(19) United States
(12) Patent Application Publication
(10) Pub. No.: US 2014/0226939 A1
(43) Pub. Date: Aug. 14, 2014

(54) OPTICAL FIBER DISTRIBUTION CABLES

(71) Applicant: OFS Fitel, LLC, Norcross, GA (US)

(72) Inventors: Mark Boxer, Pinetown, NC (US); John Emanuel George, Cumming, GA (US); Frank D. Stallworth, Beaufort, SC (US)

(73) Assignee: OFS Fitel ,LLC, Norcross, GA (US)

(21) Appl. No.: 14/346,147

(22) PCT Filed: May 1, 2012
(86) PCT No.: PCT/US2012/035964

§ 371 Date: Mar. 20, 2014

Related U.S. Application Data
(60) Provisional application No. 61/537,745, filed on Sep. 22, 2011.

(51) Int. Cl. G02B 6/44

(52) U.S. Cl. CPC G02B 6/4401
USPC 385/106

(57) ABSTRACT

Described are optical fiber distribution cables that simplify the installation process and significantly reduce the number of field splices. The distribution cables contain optical splitters within the cable structure itself, and the drop cables are also housed within the distribution cable. The optical splitters are preferably bi-directional to facilitate placement of the optical splitters inside the distribution cable.

### RELATED APPLICATIONS

This application claims the benefit of provisional application 61/537,745 filed Aug. 22, 2011, which is incorporated herein by reference.

### FIELD OF THE INVENTION

This invention relates to optical fiber cables for local distribution of optical signals in optical networks. They are specially adapted for drop line installations in a Passive Optical Network (PON).

### BACKGROUND OF THE INVENTION

(Parts of this background may or may not constitute prior art.) Fiber-to-the-premises (FTTP) from local telephone and cable service providers is rapidly being implemented. This service requires a broadband optical fiber distribution network comprising local optical fiber distribution cables that are installed in neighborhoods and city streets. These are commonly referred to as Passive Optical Networks (PONs). The basic architecture is point-to-multipoint. The local distribution cable is a large fiber count (multi-fiber) cable. Single fiber or few fiber cables are used for the “drop” line from the street to the premises. In many cases, aerial drop lines are used, and these may have special requirements. In other cases, buried drop lines are used, and these may have different requirements.

A key to a PON is some form of effective optical splitter. The optical signal from the cable service provider and/or telephone service provider is routed into a local neighborhood over a distribution cable. At a point in the PON, typically in or near the neighborhood to be serviced, the optical signal in the fiber cable is split using a 1×N optical splitter. The output of the optical splitter is a group of N optical fibers, each with the identical optical signal as the main feeder fiber. Each of the N optical fibers is intended to be optically connected to a given subscriber. The optical splitters are typically housed in a splitter box located in the neighborhood being served.

As will be described in more detail below, conventional PONs contain multiple feeder and distribution fibers, and serve many subscribers in multiple neighborhoods. The fibers and cables that serve as the input to the splitter are typically known as feeder fibers and cables. The output fibers and cables from the splitter to a final drop closure are known as distribution fibers and cables. Dozens of fibers for either the feeder or distribution function are housed in one cable. Finally, the fibers and cables that connect the final drop closure to the home are known as drop fibers and cables. Since only one fiber is most often needed to provide service to the home, drop cables are typically lower fiber count cables.

A typical installation procedure for a PON is to route the feeder cable to the neighborhood to be served. The cable is opened and one or more feeder fibers are removed from the cable and suitably connected to the neighborhood splitter box. If for example the splitter is a 1×32 optical splitter, thirty three splices are made at the splitter location. If more than one splitter is housed at the splitter location, 33 splices are made for each additional splitter. The thirty two distribution optical fibers at the output of the splitter are routed along the network right-of-way and ultimately field spliced or connected to drop cables in drop closures or drop terminals, which are then routed to thirty two individual subscriber locations. Each typical drop closure feeds an average roughly 5-6 subscribers and sometimes as few as 1-2 subscribers per closure. The procedure is repeated for each neighborhood served.

Existing methods for making the drop to the home include field splicing and using pre-connectorized hardened or non-hardened connectors. Field splicing, while very reliable and relatively inexpensive, is more time consuming and requires a drop closure. Using non-hardened pre-connectorized cables also requires a drop closure to house them, which adds material cost, labor cost, light loss (attenuation) due to the mechanical nature of the connection, and complexity to the network. Hardened connectors also require a closure and a terminal that houses connector adapters. This scenario adds significantly more cost to the network, adds more light loss to the network, and potentially reduces reliability.

More efficient PON distribution systems, in terms of both improved design and simpler installation, would be an important advance in the technology.

### STATEMENT OF THE INVENTION

We have designed an optical fiber distribution cable that simplifies the installation process, eliminates the last drop splice or connector closure, and significantly reduces the number of field splices. This is enabled by a cable structure wherein the optical splitters are contained within the cable itself, and the feeder and distribution fibers, and drop cables are also housed within the distribution cable. The optical splitters are preferably bi-directional to facilitate placement of the optical splitters inside the distribution cable.

### BRIEF DESCRIPTION OF THE DRAWING

The invention may be more clearly described with the aid of the drawing, in which:

FIG. 1 is a schematic view of a typical PON from the main optical signal source and distribution and feeder cable to the subscriber locations;

FIG. 2 is schematic representation of multiple main distribution fibers in a distribution cable showing the locations of optical fiber splitters according to one aspect of the invention;

FIG. 3 is a more detailed representation of the distribution cable of FIG. 1 showing the organization of the distribution fibers, the optical splitters, and the drop cables;

FIGS. 4 and 5 are two embodiments of a distribution cable in cross-section;

FIG. 6 shows a bi-directional optical splitter useful in the implementation of the invention;

FIG. 7 shows details of a tandem optical splitter; and

FIG. 8 shows details of one embodiment of a bi-directional optical splitter that uses serially arranged conventional unidirectional optical splitters.

### DETAILED DESCRIPTION

It should be pointed out at the outset that any number of subscribers may be served by a given PON and its associated fiber optic cable. The distribution cable may have any number of main feeder fibers, with each feeder fiber connected as the input of the optical splitter. Conventional splitters come in split ratios from 1×2 to 1×16, 1×32, 1×64 or beyond, or any number of multiple signals to serve a local area. A distribution cable with 16 feeder fibers, each connected to a 1×32 optical splitter, may comprise a PON serving 512 subscribers. However, for simplicity, the following describes a PON with 4 feeder fibers connected to a 1×4 splitter and the OLT, and four 1×8 optical splitters. This PON will serve up to 32 subscribers. Larger networks are easily designed by extension from the network described.

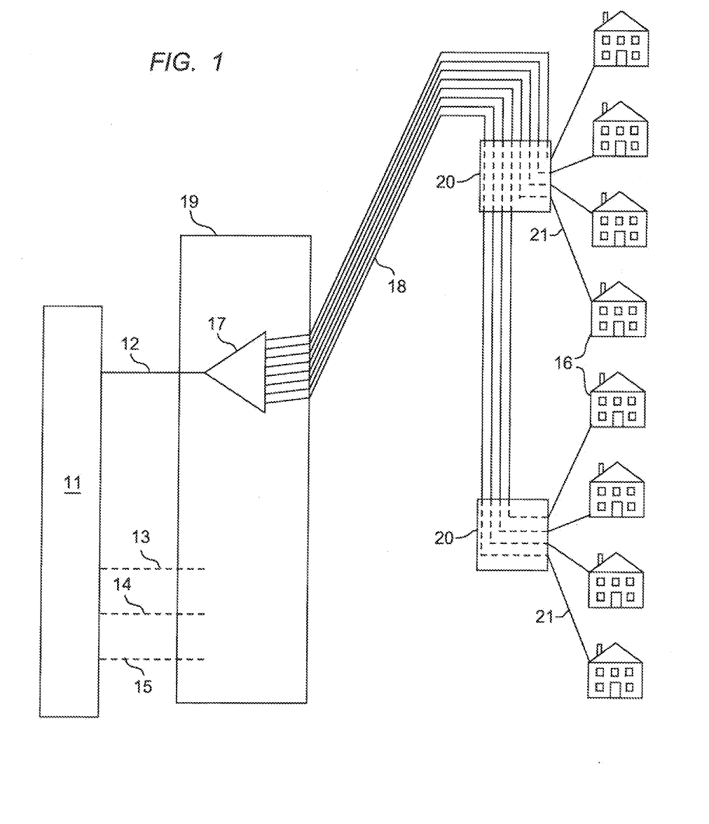

FIG. 1 is a schematic diagram of a portion of this PON where 11 represents the remote signal source, referred to below as the Optical Line Terminal (OLT) of the PON, and 12 is one of the four main feeder fibers. The other three feeder fibers are shown at 13, 14, and 15. For simplicity, the associated optical splitters for these distribution fibers are not shown. The feeder fiber 12 is connected to a 1×8 optical splitter 17. The eight outputs from the optical splitter are routed to the subscribers 16 by distribution cables 18 and drop cables 21. A drop closure or terminal 20 is used to either splice or connect the drop cables to the distribution cables.

The combination of optical splitters 17 with the input feeder fiber 12 and the distribution fibers 18, serve as an access/distribution point for the PON, and, in conventional PONs, are housed in a street cabinet, or other suitable closure. The contents of the street cabinet are indicated by dashed box 19. This facility often serves both as a signal splitter and as a patch panel, where the split optical signals are patched to distribution cables 18 which ultimately lead to the individual drop cables 21.

The portion 19 of the PON is the focus of an important aspect of this invention.

Street cabinets are metal or plastic enclosures placed above ground near the subscribers 15. They intrude on the landscape and are constantly being accessed by installation/repair crews. The small PON just described requires up to seventeen field splices or connections. Cabinets for larger PONs may contain hundreds of field connections. As mentioned earlier, field connections are known to be weak links in a PON.

According to a feature of this invention, street cabinets, along with many of the associated field boxes and closures, are essentially eliminated. The contents of the access/distribution cabinet 19 are contained within a newly designed distribution cable. The optical splitter 17 is housed permanently within the cable structure and the distribution and drop cables 18/21 are housed initially within the cable structure and become the same item, eliminating the final drop closure or terminal 20. This will be recognized as a major advance in PON technology. A portion of each of the drop cables will be removed from the distribution cable during installation. This is described in more detail below.

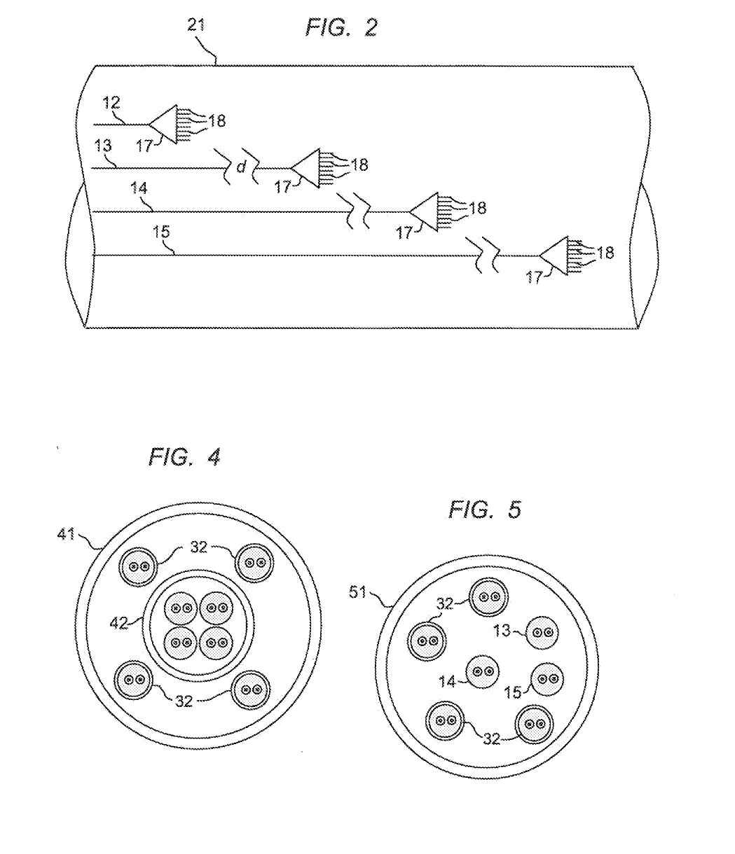

FIG. 2 shows schematically the contents of the distribution cable according to a main feature of the invention. The distribution fibers, four in this embodiment, are shown at 12-15. The optical splitters 17 and the drop cables 18 are shown spaced along the distribution cable length and are housed within the distribution cable. The space “d” represents a distance between clusters of eight (or fewer) subscribers, and a corresponding distance between access/distribution points for the PON. As should be evident, distance d may vary considerably and may be dictated by spacing between customer houses.

An important aspect of some embodiments of the invention is the inclusion of drop cables, as contrasted with drop fibers, within the cable structure.

Optical fiber drop cables may be made in several designs. Many of these designs mimic earlier copper cable versions. For example, “A-drop” optical fiber cable is an optical fiber version of A-drop copper cable, and is made in the same flat or ribbon-like configuration. More recently, round drop cables have become widely used, and, for reasons to become apparent, these are preferred for implementing the invention. However, the invention may be implemented with flat or ribbon cables.

A drop cable is defined as a cable suitable for transmitting an optical signal from the distribution fiber to a subscriber's premises. It comprises one or more optical fibers within a cable jacket. Optical fibers comprise a core and a cladding with at least one polymer coating. The core and cladding may be plastic, but are more typically glass. Optical fibers are normally too fragile to be used alone as a drop between the distribution cable and the subscriber's terminal. Accordingly, at least one protective coating for the fiber(s) is used. This is referred to here as a drop cable encasement or jacket. Thus a drop cable is defined as at least one optical fiber covered with a drop cable jacket. The drop cable may have additional protective layers including armor, and may have one or more strength layers or strength members. It may or may not be gel-filled. It may include metallic or other components to facilitate underground traceability. For indoor installations it may comprise fire-resistant materials. A wide variety of drop cable designs may be used in the practice of the invention.

A particularly suitable drop cable comprises an optical fiber encased in a tight-buffered polymer encasement. This optical fiber cable is typically 900 microns in diameter to meet standard coupling and splicing equipment and techniques. Other sizes may be used, e.g. 600 microns. The tight-buffer material is preferably a stiff, robust dual-layer nylon/ethylene-acrylic acid copolymer. Details of this encasement layer are given in U.S. Pat. No. 5,684,910, incorporated herein by reference. The encasement material can be any suitable plastic material, including PVC, thermoplastic elastomers such as DuPont's “Hytrel” materials, fluoropolymers, nylon, poly(butylene terephtalate), or UV-cured acrylate resins. The encasement is tightly fitting to the optical fiber polymer coating.

The term “encasement” as used above is defined as the primary medium that surrounds the optical fibers and may be considered equivalent to the drop cable “jacket”. While drop cables with encased designs are preferred, the invention may also be implemented with loose fiber cable designs.

The tight-buffered optical fiber may be wrapped with a strength layer of aramid yarns. Teijin Twaron BV's Twaron Type 1055 waterswellable high modulus material is suitable. The yarn may be coated with a waterswellable coating.

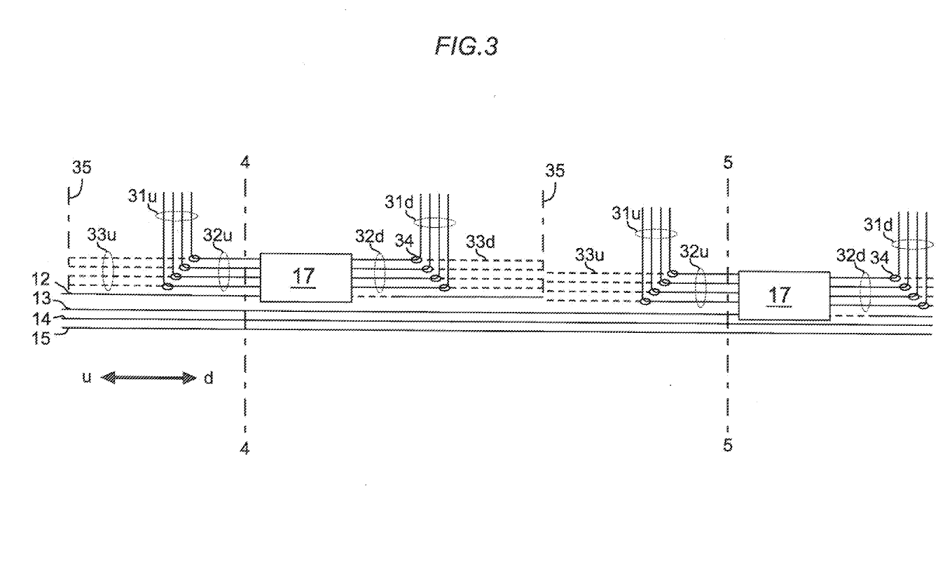

FIG. 3 shows in more detail how the drop cables are used for implementing the invention. For clarity, the contents of the distribution optical fiber cable are shown without the cable sheath. The bold arrow in FIG. 3 indicates the direction of the PON from the head end to the subscribers. The bold arrow indicates a downstream direction “d” and an upstream direction “u”.

The four feeder fibers are shown as 12, 13, 14, and 15, as in FIGS. 1 and 2. This figure shows a portion of the PON interconnecting the feeder fibers 12 and 13 with 16 subscriber locations (not shown). It will be understood that feeder fibers 14 and 15 are likewise interconnected downsteam with groups of 8 subscriber locations respectively. FIG. 3 shows optical splitters 17 associated with main feeder fibers 12 and 13 as the input to these optical splitters, and eight optical fiber drop cables as the output of each of the optical splitters. The system is designed such that the splitter is placed in the middle of its service area. Four of the optical fiber drop cables, 32d, extend downstream of the optical splitter 17, and four optical fiber drop cables, 32u, extend upstream from the optical splitter 17.

Each of the drop cables being used in the PON will be removed from the distribution cable by snaking the drop cable from the cable sheath through a cable access hole 34. The sections of the drop cables that are removed from the distribution cable are indicated as 31d and 31u. The sections of the cable that remain with the cable after installation are indicated as 32d and 32u. The original section of each drop cable, prior to installation, is indicated as 33d and 33u. Sections 33d and 33u represent the positions of the drop cable sections after the sections 31d and 32d are snaked from the cable sheath through the access hole 34. Thus cable lengths 33d, 33u and 31d, 31u show sections of the drop cables 32d and 32u before (33) and after (31) installation. To allow the drop cable sections to be removed from the distribution cable in the manner just described each drop cable must be cut at a suitable location along the distribution cable. These locations are shown in FIG. 3 as severance points 35. These cuts could be made either as the cable is being made, or as the cable is being deployed in the field during construction of the network, but before installation of the service to the customer.

It should be evident that the figures are not to scale. The optical splitters 17 may be a few centimeters in length, while the feeder and drop cables 32u and 32d may be tens, hundreds, or thousands of meters along the interior of the cable.

On inspection of FIG. 3, two conclusions may be drawn. One, the optimum location for the access/distribution points (i.e., the splitter/splice location) would be at or near the center of the cluster of eight subscriber locations. Two, the placement of the severance points 35 may advantageously take into account the length of the drop cable needed for a given subscriber connection.

From FIG. 3 it is evident that, after installation, a continuous length of each drop cable preferably extends from the optical splitter 17 to the Optical Node Terminal (ONT) location at each subscriber's premises. That eliminates the need for problematical field connections or splices at the cable access holes 34 between the distribution cable and the conventional drop to the subscriber location.

It is also important to recognize that most of the fiber splices between the head end of the PON and the subscriber location are physically located within the distribution cable. That means that, not only are the splice locations protected from potentially hostile environments, but the splices may be factory installed. However, another embodiment of the invention could entail the cable trunk and drop cable structure without the splitter spliced into it, to enable the customer to splice in the splitter at an appropriate location.

An advantage to distribution cable designed according to the invention is that the main part of the PON can be custom engineered for given clusters of subscribers. The installation of the PON is thereby greatly simplified, resulting in very substantial savings in installation cost.

The feeder fibers in FIG. 3 are shown as extending downstream of the associated access/distribution point. However, the fiber 12 is shown as a dashed line in FIG. 3 indicating it is not connected past the access/distribution point. It may be retained in the cable structure as a dummy fiber, either to fill the cable or for use as a spare fiber downstream. If the cable is factory engineered and manufactured, it may be omitted from the cable structure downstream of where it is connected to its associated optical splitter. These feeder fibers may be contained in a conventional buffer tube, and in most embodiments of the invention will not be encased in a cable structure similar to the drop cables, in order to minimize the overall size of the composite cable.

It will be recognized that the distribution cable is preferably designed so that the drop cables can be snaked easily from the overall cable structure. A variety of expedients for facilitating this will occur to those skilled in the art. For example, the drop cable structure may mimic cables designed for duct installations by using friction-reducing materials, where friction between cables is minimized to allow cables to be pulled through ducts. In addition, duct cable installation techniques may be used in connection with the installation of PONs according to this invention.

An expedient that may be useful in the installation phase is to install shorter drops before longer drops. This can be used when the drop cable lengths are factory designed and custom manufactured. Shorter lengths of drop cable will normally be easier to pull than longer drops. When a short drop cable is removed from the distribution cable it leaves added space to facilitate removal of the longer drops.

Pre-engineering distribution cables also allows cable access openings (34 in FIG. 3) to be installed in the factory. In some applications, a pre-engineered distribution cable may contain a combination of drop cables, jacketed as just described, along with drop fibers that are connected in the usual way, i.e., spliced to conventional drop cables on exit from the distribution fiber cable.

Similarly, it is within the scope of this invention to provided drop cable stubs contained within the distribution cable. In this case one or more stubs may be shorter than the overall required drop cable length. With reference to FIG. 3, one or more of the drop cables 31 may not complete the entire drop length to the subscriber, or even a substantial part of the drop length, before being spliced to another drop cable length.

A section 4-4 of the distribution cable of FIG. 3 is shown in FIG. 4 with outer cable sheath indicated by 41. An optional buffer tube 42 contains the feeder fibers (corresponding to fibers 12-15 in FIG. 3). The drop cables 32 are shown randomly bundled within the cable.

FIG. 5 shows the section 5-5 in FIG. 3. Here the buffer tube is omitted and the distribution fibers 13, 14, and 15, as well as the drop cables 32, are bundled within cable 51. (Distribution fiber 12 has been dead-ended at this point along the cable length). It should be noted that in both FIG. 4 and FIG. 5 the drop cables are represented as optical fibers within a cable jacket as described earlier. The distribution fibers may or may not be jacketed, but are shown as unjacketed.

The optical splitters 17 (FIG. 1-3) may have a variety of constructions. Conventional PONs use fused bi-conic splitters or PLC (Planar Lightwave Circuit) splitters. However, for placement within the cable structure, according to a main feature of this invention, it is necessary that the splitters be small enough to fit within the cable, preferably resulting in a minimum or no bulge to the outside cable sheath that may otherwise hinder duct or similar constricted space installations. The splitters may or may not be housed in an appropriate housing to facilitate appropriate fiber routing. Optical splitters with 1×8 functionality, and even 1×32 functionality, are available with a width of 10 mm or less. The length of the PLC splitter is of less importance than the width, since the cable diameter is the limiting parameter.

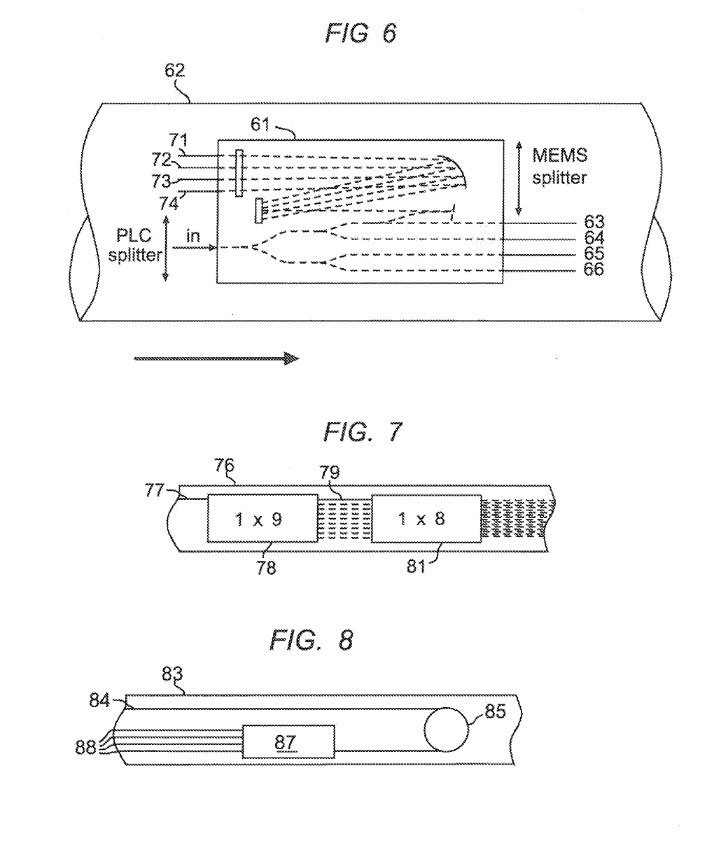

According to a preferred embodiment of the invention a bi-directional splitter is used. Since the drop cables in the distribution cable design of FIG. 3 extend both downstream from the optical splitter, as well as upstream, it should be evident from inspection that a bi-directional optical splitter will implement this design without the need for severe bends in the optical fibers. An example of a bi-directional optical splitter is shown in FIG. 6, where bi-directional optical splitter 61 is shown contained within distribution fiber cable 62. The bi-directional optical splitter 61 has a dual design. Part of the optical splitter is a PLC, and part is a MEMS. The dual design is used for convenience to illustrate two forms of optical splitters that may be combined to produce a bi-directional splitter. In the optical splitter 61 a distribution fiber is input to the device as shown. The downstream direction is indicated by the bold arrow below cable 62. The PLC splitter section splits the signal in the distribution fiber into eight outputs. Four of these, 63, 64, 65, and 66, extend in the downstream direction. The signal is split as shown so that a fifth output is input into the MEMS splitter section. As is well known, a MEMS splitter is capable of re-directing an optical beam through 180 degrees as shown, producing four outputs 71, 72, 73 and 74 on the upstream direction.

As just described, the bi-directional optical splitter 61 is shown with two sections, a PLC splitter section and a MEMS section. It will be apparent to those skilled in the art that a similar bi-directional splitter may be implemented in an all MEMS device. It should also be evident that, while the optical splitter 61 is shown with both the PLC section and the MEMS section on a common device substrate or support, the bi-directional splitter may be just as easily produced in two separate devices with e.g., one downstream of the other. In that manner the splitter may have a smaller overall width dimension. For example, a small inexpensive 1×2 splitter may be connected to a given distribution fiber, with the two outputs made inputs, respectively, to a splitter providing downstream outputs and a splitter providing upstream outputs. Alternatively, a PLC downstream splitter may be designed with an extra output waveguide routed through a 180 degree turn to be connected to the upstream splitter. Or, the PLC splitter will have outputs in 2 directions, upstream and downstream, simplifying the installation and eliminating the need for fiber bends within the splitter structure.

Likewise, for a very large PON the optical splitter may be separated into multiple devices at the same access/distribution point to accommodate a large number of splits. In this manner, the issue of the size (width) of the splitter fitting into a given cable diameter may be surmounted by recognizing that the limiting dimension is the width not the length. So one may use, for example, a 1×9 splitter and route the 9th output to another 1×8 splitter just downstream to produce a 1×16 splitter with half the width of a conventional 1×16 splitter. This device is referred to here as a tandem splitter and is illustrated in FIG. 7, where the distribution cable 76 is shown with distribution fiber 77. For clarity, the other distribution fibers and the drop cables are not shown in the figure. The tandem splitter has two sections, arranged in tandem as shown, with 1×9 splitter 78 producing 9 outputs as shown, and one output 79 connected as the input to the second tandem splitter 81. The device produces the 16 outputs shown to the right of the figure, and has a width of half of a conventional 1×16 splitter. It will be evident that any number of splitter combinations may be used to implement the tandem splitter concept. Also, more than two splitters may comprise the tandem sequence. Nominally, a 1×N tandem splitter with x splitters comprises: (x−1) tandem splitter sections each described by 1×(N/x)+1, connected to a 1×N/x section as the last section in the tandem. However, it should be evident that N need not be the same in each section. In that case, where N=N′+N″, and x=2, the 1×N tandem splitter comprises a 1×N′+1 section, connected to a 1×N″ section. A variety of equivalent arrangements may occur to those skilled in the art.

A simpler, and possibly more cost-effective, bi-directional splitter may be produced by folding one of the distribution optical fibers through a 180 degree arc to attach to a PLC optical splitter oriented with the outputs facing upstream in the optical fiber distribution cable. This is illustrated in FIG. 8 where a distribution optical fiber 84 in optical fiber distribution cable 83 is wound around an optional element 85 that serves as a mandrel to smoothly redirect the distribution fiber through a 180 degree arc. The redirected distribution fiber is and connected to a 1×4 PLC splitter 87 upstream from the mandrel. The element 85 that serves a mandrel function is preferably small, e.g., a disk or ring. In a preferred embodiment it comprises a rigid overlay sleeve. The mandrel element ensures a smooth bend in the optical fiber and, if the element is approximately the diameter of the cable, ensures the maximum allowed bend diameter. The output fibers 88 may correspond to output fibers 71-74 in FIG. 6.

FIG. 8 shows an arrangement for redirecting an upstream distribution fiber to four downstream optical fibers, and represents a general technique for producing upstream outputs. The downstream outputs are not shown in this figure. Corresponding downstream outputs may be produced by splitting the distribution fiber into a downstream fiber and an upstream fiber. For example, a small inexpensive 1×2 splitter may be connected to a given distribution fiber, with the two outputs made inputs, respectively, to a conventional PLC splitter providing downstream outputs and a splitter, like splitter 87 in FIG. 8, providing upstream outputs.

The drop cables in FIGS. 4 and 5 are shown as containing two optical fibers. However, the drop cables may contain a single optical fiber, or more than two optical fibers. For FTTH applications, and small business installations, drop cables with 1-3 optical fibers will normally be used.

Various other modifications of this invention will occur to those skilled in the art. All deviations from the specific teachings of this specification that basically rely on the principles and their equivalents through which the art has been advanced are properly considered within the scope of the invention as described and claimed.

1. Optical fiber distribution cable comprising:
a) M feeder optical fibers;
b) N optical fiber drop cables;
c) 1×N optical splitter in the optical fiber distribution cable with the input connected to an M feeder optical fiber and the N outputs connected to the N optical fiber drop cables.

2. The optical fiber distribution cable of claim 1 wherein M is at least 2 and N is at least 4.

3. The optical fiber distribution cable of claim 2 wherein the N optical fiber drop cables comprise optical fibers encased in a conformal encasement.

4. The optical fiber distribution cable of claim 2 wherein the length dimension of the optical fiber distribution cable extends from an upstream direction u to a downstream direction d and a group Nd of the N optical fiber drop cables extends from the optical splitter downstream in the cable and a group Nu of the N optical fiber drop cables extends from the optical splitter upstream in the cable.

5. The optical fiber distribution cable of claim 1 comprising a plurality x of groups N to Nx of optical fiber drop cables and a plurality x of 1×N optical splitters in the optical fiber distribution cable with the inputs of the optical splitters connected to an M feeder optical fiber and the N outputs connected to one of the groups N to Nx of the optical fiber drop cables.

6. The optical fiber distribution cable of claim 4 wherein the optical splitter is bi-directional from u to d with a group Nu of outputs on the bi-directional splitter connected to the group Nu of the N optical fiber drop cables and the group Nd of outputs from the bi-directional splitter connected to the group of Nd of the N optical fiber drop cables.

7. The optical fiber distribution cable of claim 6 wherein the bi-directional splitter contains MEMS elements.

8. The optical fiber distribution cable of claim 6 wherein the input to the bi-directional splitter connected to the group Nu of the N optical fiber drop cables is a distribution fiber extending downstream and redirected 180 degrees to extend upstream.

9. The optical fiber distribution cable of claim 2 wherein the optical splitter is a tandem splitter having at least 2 sections.

10. A method for routing, through a plurality N of optical fiber drop cables, optical fiber to a plurality of subscribers located a distance from an optical fiber distribution cable, wherein the optical fiber distribution cable comprises M feeder optical fibers connected to N optical fiber drop cables through a 1×N optical splitter within the optical fiber distribution cable, with the input of the optical splitter connected to an M feeder optical fiber and the N outputs of the optical splitter connected to the N optical fiber drop cables, comprising the steps of:
a) opening the optical fiber distribution cable;
b) withdrawing an optical fiber drop cable from optical fiber distribution cable, and
c) routing the optical fiber drop cable at least partially over the distance to a first subscriber,
d) sealing the opening in the optical fiber distribution cable, and
repeating steps a) to d) for a second subscriber.

11. The method of claim 10 wherein at least one of the optical fiber drop cables is routed over the complete distance from the optical fiber distribution cable to the subscriber.

12. The method of claim 10 wherein the length dimension of the optical fiber distribution cable extends from an upstream direction u to a downstream direction d and a group Nd of the N optical fiber drop cables extends from the optical splitter downstream in the cable and a group Nu of the N optical fiber drop cables extends from the optical splitter upstream in the cable and the optical fiber splitter is located between the first subscriber and the second subscriber.

13. The method of claim 12 wherein an optical fiber in the group Nd is routed to the first subscriber and an optical fiber in the group Nu is routed to the second subscriber.

14. The method of claim 10 wherein M is at least 2 and N is at least 4.

15. The method of claim 10 wherein the N optical fiber drop cables comprise optical fibers encased in a conformal encasement.

16. The method of claim 10 wherein the optical fiber distribution cable comprises a plurality x of groups N to Nx of optical fiber drop cables and a plurality x of 1×N optical splitters in the optical fiber distribution cable with the inputs of the optical splitters connected to an M feeder optical fiber and the N outputs connected to one of the groups N to Nx of the optical fiber drop cables.

17. The method of claim 16 wherein the optical fiber drop cables are severed at a severance point within the optical fiber distribution cable, with the severance point located between the plurality x of optical splitters.

18. The method of claim 17 wherein the severance point is related to the distance between the optical fiber distribution cable and one or more subscribers.

19. The method of claim 11 wherein there are no optical fiber splices or connections in the drop cable from the optical splitter and the subscriber.

20. Optical fiber distribution cable comprising in combination within a cable sheath:
a) a plurality of feeder optical fibers; and
b) a plurality of optical fiber drop cables.
